(19) United States
(12) Patent Application Publication
(10) Pub. No.: US 2011/0184853 A1
(43) Pub. Date: Jul. 28, 2011

(54) TALKING TRANSACTIONS

(75) Inventors: Timothy James Mark, Berkeley, CA (US); Felix A. Mon, Jacksonville, FL (US); Jason Michael Ackiss, Matthews, NC (US); Maile George, Concord, CA (US); Robert Fleetwood Armstrong, Charlotte, NC (US); Carl Frederick, II, Newark, DE (US)

(73) Assignee: BANK OF AMERICA CORPORATION, Charlotte, NC (US)

(21) Appl. No.: 12/695,894

(22) Filed: Jan. 28, 2010

(51) Int. Cl. G06Q 40/00; G06F 15/16

(52) U.S. Cl. 705/39; 709/206

(57) ABSTRACT

Embodiments of the invention relate to systems, methods, and computer program products for providing audio messages relating to financial transactions. For example, one embodiment of the invention provides a financial institution's computer apparatus having a memory communicably coupled to a communication device and a processor. In one embodiment, the memory stores information about a financial account including information about a system to use to communicate a message comprising an audio component to a person associated with the financial account, and the processor is configured to receive an indication of a financial transaction affecting the financial account and use the communication device to communicate an audio message containing information relating to the financial transaction to the person associated with the financial account by using the system.

### FIELD

In general, embodiments of the invention relate to methods, systems and computer program products for providing audio messages relating to financial transactions.

### BACKGROUND

Consumers today have a variety of digital tools available to them which allow them to review and manage their financial transaction data. For example, transaction summaries are often available in online banking accounts accessible via mobile communication devices. In other instances, consumers may receive e-mail or text messages containing transaction data from recent transactions. Unfortunately, visually impaired individuals are often unable to readily take advantage of such tools. Such individuals may use screen readers, magnification software, and other accessible computer technology in order to try to obtain value from products and functionality that were designed and implemented to be utilized by consumers without visual impairments. While visually impaired consumers may be able to eventually comprehend the financial transaction content presented visually by the various tools of the prior art through application of specially-designed tools for the visually impaired, this is an inefficient and imprecise manner of obtaining the relevant information that is also ill-suited for translation into the handheld computing field (as accessible technology for the visually impaired is often designed for use with personal computers such as laptops and desktops). Therefore, there remains a need for an improved system for providing visually-impaired consumers with the ability to readily review and manage their financial transactions.

### SUMMARY OF EMBODIMENTS OF THE INVENTION

Embodiments of the invention relate to systems, methods, and computer program products for providing audio messages relating to financial transactions. In one embodiment of the invention an apparatus is provided that comprises a communication device, a memory device, wherein the memory device stores information about a financial account, wherein the information about the financial account includes information about a system to use to communicate a message to a person associated with the financial account, wherein the message comprises an audio component, and a processing device communicably coupled to the communication device and the memory device, wherein the processing device is configured to receive an indication of a financial transaction affecting the financial account and use the communication device to communicate a message comprising an audio component to the person associated with the financial account by using the system, wherein the message comprises information relating to the financial transaction.

In some embodiments, the message comprises the date of the financial transaction, the amount of the financial transaction, or the identity of a party involved in the transaction. The person associated with the financial account may be a consumer making a purchase as at least part of the financial transaction. In some embodiments, the processing device is configured to communicate the message via MMS, email, voicemail, or automated telephone call. In some embodiments, the processing device is configured to communicate the message over a network to be accessed by a remote device.

In some embodiments, the information about the financial account may further include information about when to communicate messages to the person associated with the financial account. In such embodiments, the information about when to communicate messages to the person associated with the financial account may be a predefined number of financial transactions or a predefined time period. In other embodiments, the information about when to communicate messages to the person associated with the financial account may include a type of financial transaction.

In some embodiments, the apparatus comprises a mobile telephone system. In some embodiments, the audio component comprises information relating to the financial transaction. In such embodiments, the information relating to the financial transaction may include the date of the financial transaction, the amount of the financial transaction, or the identity of a party involved in the transaction. In some embodiments, the processing device is configured to encrypt the message and the memory device contains instructions for decrypting the message, wherein the instructions are available for download by the person associated with the financial account.

Other embodiments of the invention provide a method implemented by a computerized apparatus configured for providing an audio message containing financial transaction information, the method comprising: (1) storing information about a financial account, wherein the information about the financial account includes information about a system to use to communicate a message to a person associated with the financial account, wherein the message comprises an audio component; (2) receiving an indication of a financial transaction affecting the financial account; and (3) communicating a message comprising an audio component to the person associated with the financial account by using the system; wherein the message comprises information relating to the financial transaction.

In such embodiments, the message may include the date of the financial transaction, the amount of the financial transaction, or the identity of a party involved in the transaction. The person associated with the financial account may be a consumer making a purchase as at least part of the financial transaction. In some embodiments, communicating a message comprising an audio component may be accomplished by transmitting an MMS, email, voicemail, or automated telephone call. In some embodiments, the information about a system comprises a telephone number or email address associated with the person associated with the financial account. According to some embodiments, communicating a message comprising an audio component may be accomplished by posting an audio file to a website accessible by a remote device via a network. In some embodiments, the information about the financial account further includes information about when to communicate messages to the person associated with the financial account. In such embodiments, the information about when to communicate messages to the person associated with the financial account may include a predefined number of financial transactions or a predefined time period or a particular type of financial transaction.

Other embodiments of the invention provide a computer program product for providing an audio message containing financial transaction information, the computer program product comprising a computer-readable medium having computer-readable program instructions stored therein, wherein said computer-readable program instructions comprise: first instructions configured for storing information about a financial account, wherein the information about the financial account includes information about a system to use to communicate a message to a person associated with the financial account, wherein the message comprises an audio component; second instructions configured for receiving an indication of a financial transaction affecting the financial account; and third instructions configured for communicating a message comprising an audio component to the person associated with the financial account by using the system, wherein the message comprises information relating to the financial transaction.

Other embodiments of the invention provide an apparatus comprising a communication device, a memory device, and a processing device communicably coupled to the communication device and the memory device, wherein the processing device is configured to obtain via a network and store in the memory device instructions for decrypting an encrypted message from a financial institution comprising an audio component, access an encrypted message from a financial institution comprising an audio component, wherein the audio component comprises information relating to a financial transaction associated with a user of the apparatus, decrypt the message using the instructions, and instruct the communication device to audibly communicate the audio component of the message to the user. In some embodiments, the audio component comprises the date of the financial transaction, the amount of the financial transaction, or the identity of a party involved in the transaction. In some embodiments, the apparatus is a mobile telephone.

### BRIEF DESCRIPTION OF THE DRAWINGS

Having thus described embodiments of the invention in general terms, reference will now be made to the accompanying drawings:

FIG. 1 illustrates a financial transaction audio messaging system and an environment in which the system exists and the methods described herein are implemented according to an embodiment of the invention;

FIG. 2 is a flow chart illustrating an exemplary method of providing audio messages relating to financial transactions, from the perspective of a consumer, in accordance with an embodiment of the invention; and

FIG. 3 is a flow chart illustrating an exemplary method of providing audio messages relating to financial transactions, from the perspective of a banking institution, in accordance with an embodiment of the invention.

### DETAILED DESCRIPTION OF EMBODIMENTS OF THE INVENTION

Embodiments of the present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art, the present invention may be embodied as a method, system/apparatus, computer program product, or a combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, infrared, or semiconductor system, apparatus, device, or medium. More specific examples of the computer readable medium include, but are not limited to, a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

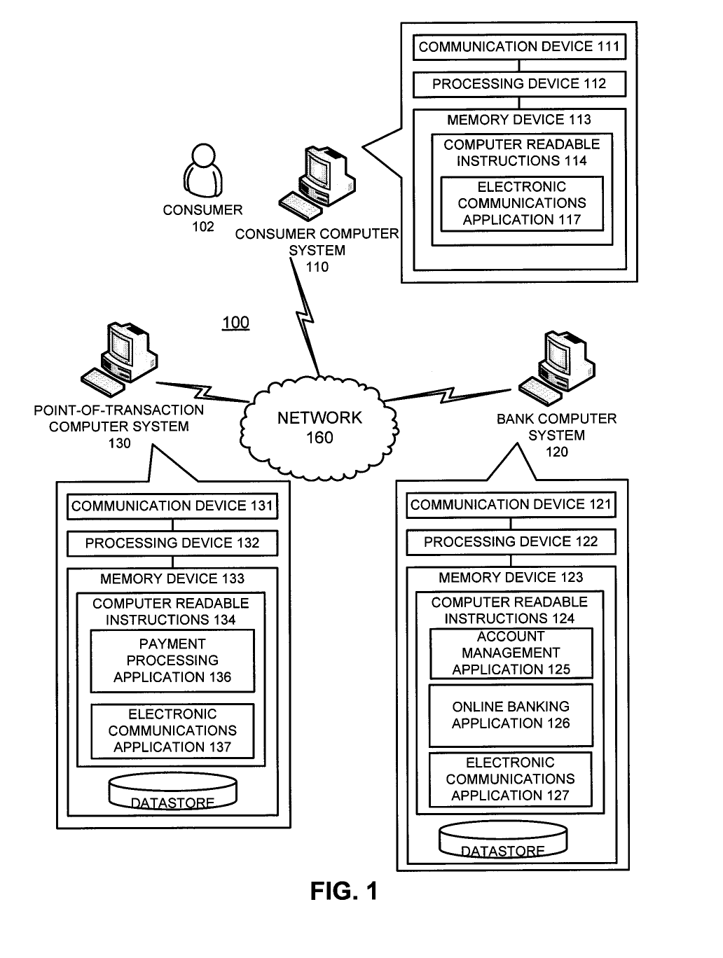

FIG. 1 illustrates an exemplary financial transaction audio messaging system 100 environment in which an embodiment of the present invention exists. As shown in FIG. 1, in one embodiment, the financial transaction audio messaging system 100 includes a consumer computer system 110, a point-of-transaction (“POT”) computer system 130, and a bank computer system 120. Although, for simplicity, FIG. 1 only illustrates one of each computer system, it will be appreciated that, in some embodiments of the invention, there will be many consumer computer systems 110, many POT computer systems 120, and/or many bank computer systems 120. Furthermore, although the term “bank” is used herein to describe some embodiments of the invention, other embodiments of the invention many involve other financial institutions in addition to or as an alternative to a bank. As used herein and in the claims, the term “financial institution” refers to an institution that provides financial services for its clients or members by processing financial transactions for its clients or members. Financial institutions can include, but are not limited to, banks, building societies, credit unions, stock brokerages, asset management firms, savings and loans, money lending companies, insurance brokerages, insurance underwriters, dealers in securities, and similar businesses. Retail, wholesale, and service businesses, as well as manufacturers, may also process financial transactions as disclosed herein. As such, the bank computer system 120 of FIG. 1 could be the computer system of another financial institution involved in banking or other financial transactions, but not traditionally thought of as a bank.

Referring again to the embodiment illustrated in FIG. 1, the consumer computer system 110, and the point-of-transaction (“POT”) computer system 130 are operatively coupled, via a network 160, to the bank computer system 120. The network 160 may be a global area network (GAN), such as the Internet, a wide area network (WAN), a local area network (LAN), or any other type of network or combination of networks. The network 160 may provide for wireline, wireless, or a combination of wireline and wireless communication between devices in the network. It will be understood that when two components are described herein as communicating over a network, the components may be directly coupled to each other or indirectly coupled via one or more other components. Furthermore, although at least some of the systems described herein are described as having several unique components, these components need not be separate and distinct from one another, and two or more of such components may, in some embodiments, be combined into a single component that performs all of the functions of the multiple components so combined as described herein.

As illustrated in FIG. 1, the consumer computer system 110 generally comprises a communication device 111, a processing device 112, and a memory device 113. The processing device 112 is operatively coupled to the communication device 111 and the memory device 113. The processing device 112 uses the communication device 111 to communicate with the bank computer system 130 over the network 160. The processing device 112 also uses the communication device 111 to communicate with the consumer 102. As such, the communication device 111 generally comprises a modem, server, wireless card, radio, and/or other device for communicating with other devices on the network 160, and a display, mouse, keyboard, microphone, touch pad, touch screen, speaker, and/or other device for communicating with the consumer 102.

As used herein and in the claims, the term “processing device” generally refers to circuitry used for implementing communication and logic functions of the system in which it resides. A processing device may include, for example, a digital signal processor device, a microprocessor device, and various analog-to-digital converters, digital-to-analog converters, and other support circuits. Control and signal processing functions of a system are allocated between these processing devices according to their respective capabilities. The processing device may also include functionality to operate one or more computer applications based on computer-readable instructions (i.e., computer program code) thereof, which may be stored in a memory device in communication therewith. As used herein and in the claims, the term “memory device” generally refers to any device having computer-readable medium configured to store, for example, data and/or one or more computer applications.

As further illustrated in FIG. 1, the consumer computer system 110 includes computer-readable instructions 114 stored in the memory device 113, which include the computer-readable instructions 114 of an electronic communications application 117. The electronic communications application 117 includes one or more computer programs that, when executed by the processing device 112, allow the consumer 102 to receive, store, and transmit electronic messages or access electronic messages via a website utilizing the communication device 111. For example, in one embodiment of the present invention, the electronic communications application 117 may include an email application, and/or an audio messaging application. In some embodiments, the electronic communications application 117 may also include an Internet browsing application or other application that allows the user to access the online banking platform 126 operated by the bank computer system 120. In still other embodiments, the electronic communications application 117 is an application configured to receive encrypted messages from the bank computer system 120, decrypt the messages, and instruct the communication device 111 to communicate the messages to the consumer 102 in audio format. In some embodiments, such application is a customized application that the bank may provide for the consumer 102 to download onto the consumer computer system 110.

In one embodiment, the consumer computer system 110 is a consumer's desktop computer. In other embodiments, however, the consumer computer system 110 is a consumer's mobile computing device, which may include, for example, a mobile telephone, a personal digital assistant, a mobile picture taking device, a laptop computer, a mobile email device, a mobile texting device, a mobile music device, a wrist computer, and/or any other mobile terminal. It should be understood that FIG. 1 illustrates only one embodiment of the financial transaction audio messaging system 100 of the present invention, and that, according to some embodiments, a consumer computer system 110 is not required to implement the financial transaction audio messaging methods of the present invention. Indeed, in some embodiments and as more fully described below, the systems and methods of the present invention utilize a telephone associated with the consumer 102 rather than the consumer computer system 110, whether such telephone is a mobile telephone, landline telephone, or otherwise.

As illustrated in FIG. 1, the bank computer system 120 generally includes a communication device 121, a processing device 122, and a memory device 123. The processing device 122 is operatively coupled to the communication device 121 and the memory device 123. The processing device 122 uses the communication device 121 to communicate with the consumer computer system 110 and the POT computer system 130 over the network 160. As such, the communication device 121 generally comprises a modem, server, wireless card, radio or other device for communicating with other devices on the network 160.

As further illustrated in FIG. 1, the bank computer system 120 includes computer-readable instructions 124 stored in the memory device 123, which include the computer-readable instructions 124 of an account management application 125, an online banking platform 126, and an electronic communications application 127. The account management application 125 includes one or more computer programs that, when executed by the processing device 122, perform account management functions such as debiting and crediting accounts based on transactions engaged in by account holders, such as consumer 102. The online banking platform 126 is an interactive web-based or mobile device solution that may be accessed by account holders to view their various accounts and perform certain transactions, such as transaction inquiries, fund transfers, bill payments, etc. Finally, the electronic communications application 127 includes one or more computer programs for receiving, storing, and transmitting electronic messages utilizing the communication device 121. Although FIG. 1 illustrates the bank computer system 120 as one system, it is important to note that there can be one or multiple systems, each with similar components that handle the various functions of the bank computer system 120.

The POT computer system 130, also sometimes referred to as a point-of-sale (POS) computer system/terminal, generally includes a communication device 131, a processing device 132, and a memory device 133. The processing device 132 is operatively coupled to the communication device 131 and the memory device 133. The processing device 132 uses the communication device 131 to communicate with the bank computer system 120 over the network 160. As such, the communication device 131 generally comprises a modem, server, or other device(s) for communicating with other devices on the network 160.

As further illustrated in FIG. 1, the POT computer system 130 contains computer-readable program instructions 134 stored in the memory device 133, including computer-readable instructions 134 of a payment processing application 136, and an electronic communications application 137. The payment processing application 136 generally includes one or more computer programs that, when executed by the processing device 132, perform payment processing functions, for example, in the case of a debit card payment, reading the debit card, contacting the issuing entity, requesting authorization from the issuing entity, receiving authorization from the issuing entity, and receiving the payment. The electronic communications application 137 includes one or more computer programs for receiving, storing, and transmitting electronic messages utilizing the communication device 131. Although FIG. 1 illustrates the POT computer system 130 as one system, it is important to note that there can be one or multiple systems, each with similar components that handle functions herein attributed to the POT computer system 130.

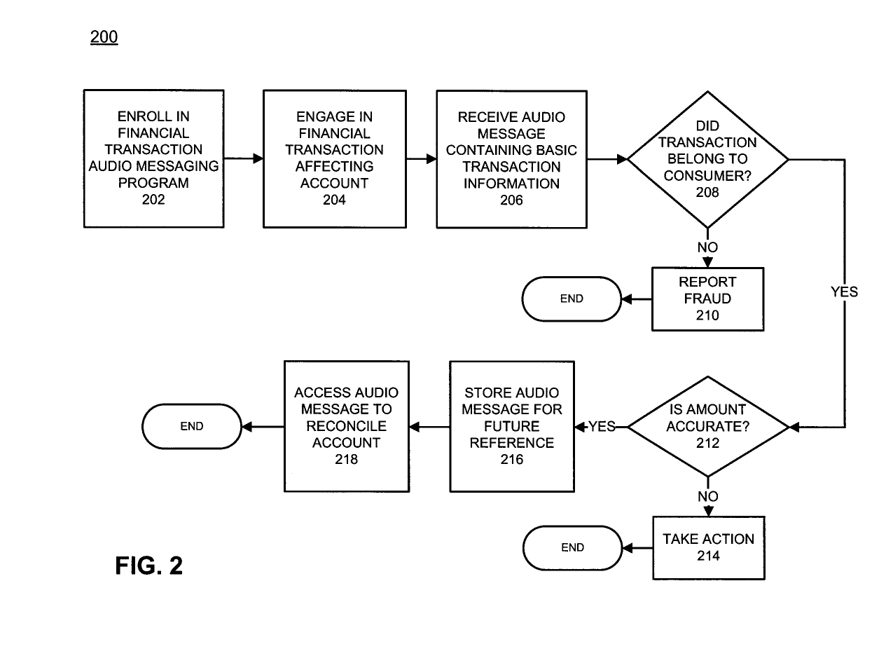

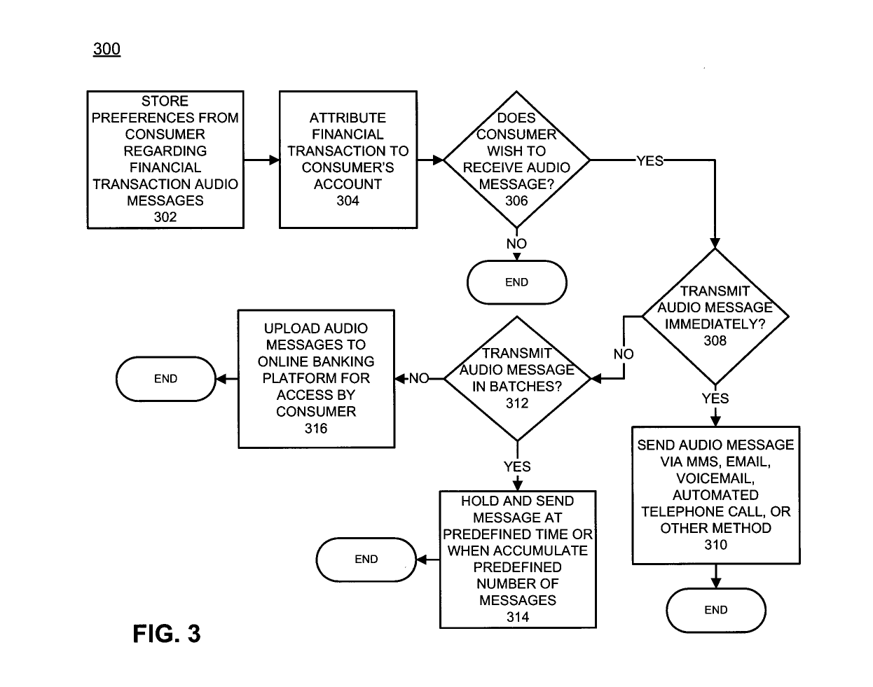

With reference now to FIGS. 2-3, embodiments of the processes of embodiments of the present invention are illustrated. In this regard, FIGS. 2 and 3 are flowcharts illustrating one embodiment of the present invention from the perspectives of the consumer 102 and the bank (as defined below), respectively. More particularly, FIG. 2 provides a flow chart illustrating an exemplary method 200 of providing financial transaction audio messages, from the perspective of a consumer, in accordance with an embodiment of the invention. FIG. 3 provides a flow chart illustrating an exemplary method 300 of providing financial transaction audio messages, from the perspective of a banking institution, in accordance with an embodiment of the invention.

A shown in block 202 of FIG. 2, according to some embodiments, the consumer 102 enrolls into a financial transaction audio messaging program operated by a banking institution that manages at least one financial account of the consumer 102 (such banking institution referred to herein as the “bank”). Enrollment may be accomplished by the consumer 102 or another party acting on behalf of the consumer 102, for example, an employee of the bank, accessing through the online banking platform 126 a financial account of the consumer 102 and recording a preference therein that the consumer 102 wishes to receive audio messages notifying the consumer 102 of financial transactions affecting that financial account. According to other embodiments, the consumer 102 may also enroll in the audio messaging program by notifying the bank, whether in person, via telephone, via email, or otherwise, that the consumer 102 would like to receive financial transaction audio messages for a specific account or portion thereof. Indeed, as used herein, the process of “enrollment” includes communicating to the bank a desire to receive audio messages notifying the consumer 102 of financial transactions affecting a particular financial account of the consumer 102 managed by the bank. In still other embodiments, the consumer 102 may not need to enroll in a financial transaction audio messaging program or otherwise notify the bank of her desire to receive audio messages, but the bank will automatically enroll the consumer 102 to receive audio messages and the consumer 102 may later opt-out.

During enrollment of the consumer 102 into the financial transaction audio messaging program, the consumer 102 may indicate her preferences as to how, when, and where the audio messages should be provided to the consumer 102. Thus, in some embodiments, the consumer 102 not only indicates that she would like to receive audio messages summarizing her financial transactions, but also provides information relating to how she would like to receive such audio messages, including by voicemail, automated telephone call, email with audio file attachment or file attachment containing audio among other media (such as video), Multimedia Messaging Service messages containing audio, or other audio messaging format. It should be understood that as used herein “audio messages” and “audio messaging” means the communication of content that includes an audio component. Thus, “audio messages” are not limited to audio recordings and content alone, but may also include audio/video recordings and other multimedia content. In some embodiments, the consumer 102 may indicate that she does not wish the audio messages to be transmitted to her, but rather posted within her account on the online banking platform 126. In other embodiments, the consumer 102 may indicate that she would like the audio messages both sent to her via one of the methods listed above or via another known method of sending audio content to a remote recipient and would like the audio messages posted to her account within the online banking platform 126. As part of the enrollment process, according to some embodiments, the consumer 102 may provide a telephone number, email address, or other contact information or online account information that will enable the bank to send the audio messages as requested.

In addition to communicating her preference regarding how and where the audio messages should be provided or transmitted, in some embodiments, the consumer 102 also indicates her preference as to how often to receive such audio messages. For example, the consumer 102 may wish to receive the audio message corresponding to a particular transaction immediately after the bank becomes aware that a transaction affecting her account has been made. Alternatively, the consumer 102 may wish to only receive summaries of her transactions on a periodic basis, for example once a day, once every two days, or once a week. In such an instance, the audio message transmitted or otherwise made available to the consumer 102 would include the transaction information for multiple transactions, rather than a single transaction. Furthermore, according to some embodiments, the consumer 102 may only wish to receive audio messages for certain types of transactions, such as withdrawals, deposits, or purchases. In some embodiments, the consumer 102 may identify a particular vendor, or a particular type of vendor, for example, clothing stores, and indicate that she would only like to receive audio messages for transactions conducted with that vendor or that type of vendor. The consumer 102 may also, in some embodiments, have selected to only receive audio messages summarizing the financial transactions affecting an account if the financial transactions involve the transfer of money over a particular threshold amount, if the financial transactions are made in particular geographic locations or if the financial transactions are made using one bank card out of multiple bank cards associated with the account. During enrollment, the consumer 102 may also determine what information will be included in the audio message, for example, the date of the transaction, the amount of the transaction, whether the transaction was a purchase, a withdrawal, a deposit, etc., and the identity of the other party involved in the transaction, including the address of such party. Indeed, it should be appreciated that there are countless ways in which the bank may wish to structure the ability of the consumer 102 to provide her preferences regarding the financial transaction audio messaging program. Thus, the consumer 102 completes enrollment by indicating her preference to receive financial transaction audio messages and her preferences regarding how and how often such audio messages should be communicated to her. Referring now to FIG. 3, and as represented by block 302, the bank receives and stores in connection with the account of the consumer 102 that was identified during enrollment, all of the preference information provided by the consumer 102 during enrollment. This stored preference information will be accessed later each time a transaction is made that affects the account.

As represented by block 204 in FIG. 2, the consumer 102 engages in a financial transaction that affects an account of the consumer 102 maintained by the bank. The bank computer system 120 is operated by or on behalf of the bank and is used to maintain the account(s) of the consumer 102. In some embodiments, the financial transaction is a payment made or received by the consumer 102. For example, the financial transaction may be the purchase of goods or services by the consumer 102 from a third party. On the other hand, the financial transaction may be the receipt of payment from a third party for services rendered by the consumer 102.

In some embodiments, the payment between the consumer 102 and the third party may be made by credit card, debit card, check, ACH transfer, or other mutually-accepted payment mechanism and effected through the use of the POT computer system 130. As used herein, the term “bank card” refers to a debit card, credit card, or any other device that is used by a consumer to effectuate a financial transaction. As used herein, the term “bank card” is not limited to cards issued by banks and, instead, also includes cards and other devices issued by other financial institutions or their agents. As used herein, the term “bank account” refers to a debit account, credit account, demand deposit account, money market account, savings account, or any other type of account that may be involved in a financial transaction. In general, and in accordance with embodiments of the present invention, the POT computer system 130 processes a bank card, check or ACH transfer payment by utilizing the payment processing application 136 and communicating with the bank computer system 120 using the communication device 131 to get authorization for and/or clearance of the payment.

With regard to the nature of the POT computer system 130, the POT computer system 130 may be any type of computer system used for processing financial transactions and may be operated by or on behalf of any entity or multiple entities, including the consumer 102 or the bank. Furthermore, the POT computer system 130 may be located at the point-of-transaction, or may be in a remote location. For example, if the consumer 102 engages in a financial transaction by purchasing goods from a vendor using her debit card, the POT computer system 130 would generally include the computer system employed by the vendor to process the debit card payment, including, for example, the computer system of the checkout register and debit card kiosk and the computer systems of the vendor's banking institution and any intermediary financial institution. Alternatively, and for the purposes of example only, if the consumer receives a payment from a third party by ACH transfer, the POT computer system 130 would generally include the computer systems employed to transfer the funds. In such a scenario, the POT computer system 130 may be owned and operated by the bank and may even be integrated with the bank computer system 120. As another example, the consumer 102 may be equipped to receive bank card payments, in which case the POT computer system 130 used to process such transactions may be owned, operated, or otherwise employed by the consumer 102. In yet another example, the consumer 102 may make a purchase online or through a mobile device system using the consumer's mobile phone or other personal computing device. In such an embodiment, the consumer's mobile phone or other personal computing device may perform the functions of bank card and bank card terminal. The mobile phone or other personal computing device may also then perform the functions of the consumer computer system 110. In other words, the consumer's mobile phone or other personal computing device may serve as both the consumer computer system 110 and a portion of the POT computer system 130, and a vendor server interacting with the consumer's mobile phone or other computing device over a network may serve as another portion of the POT computer system 130. Therefore, it will be understood that, while the POT computer system 130 is illustrated in FIG. 1 as separate from the consumer computer system 110 and the bank computer system 120, it is possible that the consumer computer system 110 or the bank computer system 120 could be combined with the POT computer system 130 and/or perform all of the functions attributed to the POT computer system 130. In other words, in some embodiments, the separations between the computer systems illustrated in FIG. 1 may be conceptual and one or more of the computer systems or portions thereof may be combined with one or more other computer systems or portions thereof.

According to different embodiments of the invention, the financial transaction itself may take on forms different from a credit card, debit card, check, or ACH transfer payment involving the consumer 102 and a third party. For example, in one embodiment, the financial transaction is a transfer of funds between multiple accounts held by the consumer 102. In other embodiments, the financial transaction is a withdrawal from or a deposit to an account of the consumer 102, whether by ATM machine, teller, or otherwise. In each of the foregoing examples, because the bank may be the entity processing the transfer, withdrawal, deposit, or clearance of the check from the account of the consumer 102, the POT computer system 130 may be operated by or on behalf of the bank. Therefore, as discussed above, it may be the case that the POT computer system 130 is not distinct from the bank computer system 120 and that these two computer systems are one and the same. As a general note, the examples of financial transactions provided herein should not limit the type of financial transaction that may be the subject of the present invention, and, indeed, any financial transaction that causes an entry to be made by the bank (using the bank computer system 120) in an account of the consumer 102 is suitable for the methods of embodiments of the present invention, whether such entry is a debit, credit, or otherwise.

As described above, where the financial transaction involving the consumer 102 involves the debiting or crediting of a consumer's bank account, the financial transaction is processed by the POT computer system 130 and the bank computer system 120 working in communication with one another. More specifically, the POT computer system 130 uses the communication device 131 and the payment processing application 136 to communicate to the bank computer system 120 information regarding the transaction to be carried out, including the amount of money at issue and the origin and destination of that money, as well as information identifying the consumer 102 and/or the particular account belonging to the consumer 102 that is affected by the transaction. The bank computer system 120 uses the information communicated from the POT computer system 130 to process the financial transaction within the bank. Essentially, the information communicated by the POT computer system 130 includes instructions to the bank computer system 120 to debit, credit, or otherwise adjust a particular account of the consumer 102. Therefore, according to some embodiments of the invention and as represented by block 304 in FIG. 3, the bank computer system 120 utilizes the account management application 125 to attribute the transaction communicated by the POT computer system 130 to the account of the consumer 102 and make an entry in the account of the consumer 102 corresponding to the transaction. In some embodiments, the entry includes a debit or credit of the particular amount that is the subject of the transaction as well as a short description of the transaction.

Once the bank has processed the financial transaction within the bank as described above, in accordance with some embodiments of the invention and as represented by block 306, the bank then determines whether the consumer 102 has previously enrolled in the financial transaction audio messaging program for the account affected by the financial transaction or otherwise stated a preference that she receive audio messages from the bank containing financial transaction information. This information is stored, for example, in the memory device 123 of the bank computer system 120 in relation to the account of the consumer 102 so that the bank could locate the information whenever a transaction affecting that account is processed. More particularly, the account management application 125, upon receiving an indication from the POT computer system 130 that there is a transaction affecting the account of the consumer 102, records the details of the transaction in the account and instructs the processing device 122 to determine whether there is information stored in the memory device 123 that instructs the bank to transmit or otherwise make available to the consumer 102 an audio message or a portion of an audio message corresponding to the financial transaction. In the event the consumer 102 has stated a preference of receiving audio messages, the banking computer system 120, according to some embodiments, will also determine how to transmit or otherwise make available to the consumer 102 an audio message relating to the financial transaction communicated by the POT computer system 130. Such a determination may be made at the same time or after the bank determines that the consumer 102 has stated a preference to receive audio messages.

Thus, in some embodiments, and as represented by block 308, the bank computer system 120 will query the preference information stored in the memory device 123 in relation to the account of the consumer 102 and will determine if audio messages should be immediately sent to the consumer 102. In the event the consumer 102 indicated a preference to receive the audio messages as soon as possible after the transaction is attributed to the account, or if the default messaging option in the financial transaction audio messaging program is to have the audio messages immediately sent, the bank computer system 120 automatically generates an audio message summarizing the financial transaction and transmits the message to the consumer 102. In particular, as represented by block 310, the bank computer system 120 retrieves from the memory device 123 the telephone number, email address, or other contact information for the consumer 102 and utilizes the electronic communications application 127 to transmit, via the communication device 121, an audio message to such telephone number, email address, etc. According to different embodiments, the message may take the form of an audio attachment, an MMS having an audio component, an automated telephone call, or other audio messaging format. In some embodiments, the message is encrypted for security purposes. In such embodiments and as described further below, the message may be decrypted after receipt by the consumer computer system 110 by the electronic communications application 117 or other application stored on the memory device 113.

If the consumer 102 has not indicated a preference to receive audio messages immediately and/or if sending audio messages immediately is not the default mode of the program, as represented by block 312, the bank computer systems 120 will determine if it should wait to send an audio message containing certain information relating to the financial transaction. For example, the consumer 102 may have indicated a preference to only receive audio messages when a certain number of transactions, such as ten, have been processed by the bank computer system 120 that affect the account of the consumer 102. Or the consumer 102 may have indicated a preference to only receive financial transaction audio messages once a day, once a week, or some other time period. In such instances, as represented by block 314, the bank computer system 120 transmits an audio message containing a summary of the financial transaction at the predetermined time or when the predetermined number of transactions has been made. The bank computer system 120 may generate the audio message summarizing the transaction immediately and hold it for transmission at a later time with other audio messages corresponding to financial transactions made during the relevant time period. However, in some embodiments, the message that is eventually sent is a master message that contains financial transaction information corresponding to multiple transactions. Thus, the bank computer system 120 is configured to identify the financial transaction that will be the subject of a future audio message, and once the predefined number of transactions have been made or the predefined period of time has lapsed, the bank computer system 120 generates a master audio message containing information summarizing all financial transactions made during the relevant period affecting the account of the consume 102 that should be sent to the consumer 102 according to the stored preference information. The bank computer system 120 uses the electronic communications application 127 to transmit the message(s) to the consumer at the telephone number, email address, or other address/number stored in the memory device 123.

As discussed above, the information contained in the audio message may include any information concerning the financial transaction and/or the account of the consumer 102 as requested by the consumer 102, for example, the date, location, type, and amount of the transaction, information about any other entities involved in the transaction, and the remaining balance in the account, etc. Therefore, according to some embodiments, the bank computer system 120 queries the memory device 123 to determine whether or not audio messages should be sent to the consumer 102, where they should be sent, how often they should be sent, and what they should contain. All of this information may be provided by the consumer 102 as preference information during enrollment or may be selected by the bank as a default setting for the financial transaction audio messaging program.

In the event audio messages are not to be transmitted to the consumer 102 at all, i.e. the preference information stored in the memory device 123 specifies that audio messages should not be send immediately nor held and sent in batches, the bank may still provide audio messages summarizing financial transactions for access by the consumer 102 via the online banking platform 126. As represented by block 316, the bank computer system 120 will, upon determining that the consumer 102 wishes to have the benefit of audio messages but does not wish to receive them at a personal telephone number, email account, or other location, post to the account of the consumer 102 accessible through the online banking platform 126, financial transaction audio messages. These messages may be posted such that one message corresponds to one financial transaction or, as with the batches previously discussed, the consumer 102 may be able to open, via the online banking platform 126, one audio file that contains summaries of multiple financial transactions. For example, the user may access a single audio message that contains summaries of all financial transactions made during the current bank account statement period. As with the other methods of delivery of audio messages, the content and form of the audio message may be highly configurable by the bank computer system 120 according to the preferences of the consumer 102. It should also be understood that the consumer 102 may elect more than one method of receiving audio messages. For example, the consumer 102 may wish to receive immediate audio messages via automated telephone call following each transaction affecting a particular account as well as be able to access a master audio message containing the transaction information for all transactions made during a certain time period via the online banking platform 126. Embodiments of the present invention may provide for providing financial transaction audio messages to consumers in one or more of the ways discussed herein.

With reference again to FIG. 2, as represented by block 206, the consumer 102 uses the communication device 111 of the consumer computer system 110 to listen to the audio message received from the bank computer system 120. In some embodiments, the consumer 102 utilizes the electronic communications application 117 to access the audio message. In the event the message has been encrypted for transmission, for example, for security reasons, the electronic communications application 117 or another application stored in the memory device 115 may be configured to decrypt the message. In some embodiments, such decryption application, whether such application is the electronic communications application 117 or another application, is a customized application offered by the bank to the consumer 102. For example, the consumer 102 may download the application onto the consumer computer system 110 from the bank computer system 120 over the Internet. The application may be offered for download on the online banking platform 126. Thus, according to some embodiments, the consumer 102 utilizes a previously downloaded application to decrypt an encrypted message containing an audio component received from the bank. For convenience purposes, such downloaded application shall be considered the same as the electronic communications application 117 that processes the message after it is received via the communications device 111 of the consumer computer system 110, however, it should be understood that these could be separate applications. According to different embodiments, upon the communications device 111 receiving the message, the electronic communications application 117 automatically or after receiving instructions from the consumer 102 instructs the communications device 111 to communicate audibly to the consumer 102 the audio component of the message.

Where the POT computer system 130 and the bank computer system 120 are able to process a payment or other transaction in real-time or near-real-time, which is the case for many of the financial transactions that are the subject of embodiments of this invention, and where the consumer has elected to have audio messages transmitted to the consumer 102 as soon as transactions are processed and attributed to the account, the consumer 102 may receive the audio message at the point-of-transaction or very shortly after leaving the point-of-transaction. This advantageously allows the consumer 102 to quickly identify transactions that do not belong to her so that a responsive action, such as putting a hold on or canceling a particular bank card, may be taken before further fraudulent charges are made. Therefore, in some embodiments and as represented by block 208, the consumer 102 will determine whether the transaction described in the message was initiated by her or a person authorized to make transactions involving her account. In the event that the transaction was not initiated by the consumer 102 or a person authorized by the consumer 102, according to some embodiments and as represented by block 210, the consumer 102 may contact the bank to report the unauthorized transaction.

In addition to allowing detection of unauthorized use of a bank card or account, embodiments of the present invention also allow consumers to determine whether they have been overcharged during transactions. This is particularly advantageous for persons with visual impairments because such individuals are especially susceptible to fraud by vendors. Visually impaired persons must often rely on the word of the cashier or salesperson that they are being charged the appropriate amount. Thus, embodiments of the present invention provide a method of communicating to a consumer 102 the actual amount charged to the account of the consumer 102. The consumer 102 listens to the audio message and, as represented by block 212, determines whether the amount of the transaction is accurate. In the event the consumer 102 recognizes that a transaction was made, but the amount of the transaction is inaccurate, then, according to block 214, the consumer 102 can take action to report the fraudulent or incorrect transaction. In one embodiment, the consumer 102 can use the consumer computer system 110 to reply to the audio message with a notification that the transaction is unauthorized and/or the amount of the transaction is incorrect.

In some embodiments, the consumer 102 may utilize the messages for purposes other than to determine whether an inaccurate or unauthorized transaction has been processed to the account of the consumer 102. For example, according to some embodiments, and as represented by block 212, the consumer 102 may store the audio message in the memory device 113 of the consumer computer system 110, or, in the event the audio message was accessed via the online banking platform 126 rather than received by the communication device 111 of the consumer computer system 110, then the consumer 102 may elect to continue to store the audio message in the memory device 123 of the bank computer system 120 such that it appears in the account of the consumer 102 accessible via the online banking platform 126. As represented by block 216, the consumer 102 may access the audio message from time to time thereafter, whether stored in the memory device 113 of the consumer computer system 110 or the memory device 123 of the bank computer system 120, in order to reconcile and balance her account.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus comprising:
a communication device;
a memory device, wherein the memory device stores information about a financial account, wherein the information about the financial account includes information about a system to use to communicate a message to a person associated with the financial account, wherein the message comprises an audio component; and
a processing device communicably coupled to the communication device and the memory device, wherein the processing device is configured to:
receive an indication of a financial transaction affecting the financial account; and
use the communication device to communicate a message comprising an audio component to the person associated with the financial account by using the system, wherein the message comprises information relating to the financial transaction.

2. The apparatus of claim 1, wherein the message comprises the date of the financial transaction, the amount of the financial transaction, or the identity of a party involved in the transaction.

3. The apparatus of claim 1, wherein the person associated with the financial account comprises a consumer making a purchase as at least part of the financial transaction.

4. The apparatus of claim 1, wherein the processing device is configured to communicate the message via MMS, email, voicemail, or automated telephone call.

5. The apparatus of claim 1, wherein the processing device is configured to communicate the message over a network to be accessed by a remote device.

6. The apparatus of claim 1, wherein the information about the financial account further includes information about when to communicate messages to the person associated with the financial account.

7. The apparatus of claim 6, wherein the information about when to communicate messages to the person associated with the financial account comprises a predefined number of financial transactions or a predefined time period.

8. The apparatus of claim 6, wherein the information about when to communicate messages to the person associated with the financial account comprises a type of financial transaction.

9. The apparatus of claim 1, wherein the apparatus comprises a mobile telephone system.

10. The apparatus of claim 1, wherein the audio component comprises information relating to the financial transaction.

11. The apparatus of claim 1, wherein the information relating to the financial transaction comprises the date of the financial transaction, the amount of the financial transaction, or the identity of a party involved in the transaction.

12. The apparatus of claim 11, wherein the processing device is configured to encrypt the message and the memory device contains instructions for decrypting the message, wherein the instructions are available for download by the person associated with the financial account.

13. A method implemented by a computerized apparatus configured for providing an audio message containing financial transaction information, the method comprising:
storing information about a financial account, wherein the information about the financial account includes information about a system to use to communicate a message to a person associated with the financial account, wherein the message comprises an audio component;
receiving an indication of a financial transaction affecting the financial account; and
communicating a message comprising an audio component to the person associated with the financial account by using the system; wherein the message comprises information relating to the financial transaction.

14. The method of claim 13, wherein the message comprises the date of the financial transaction, the amount of the financial transaction, or the identity of a party involved in the transaction.

15. The method of claim 13, wherein the person associated with the financial account comprises a consumer making a purchase as at least part of the financial transaction.

16. The method of claim 13, wherein communicating a message comprising an audio component comprises transmitting an MMS, email, voicemail, or automated telephone call.

17. The method of claim 16, wherein the information about a system comprises a telephone number or email address associated with the person associated with the financial account.

18. The method of claim 13, wherein communicating a message comprising an audio component comprises posting an audio file to a website accessible by a remote device via a network.

19. The method of claim 13, wherein the information about the financial account further includes information about when to communicate messages to the person associated with the financial account.

20. The method of claim 19, wherein the information about when to communicate messages to the person associated with the financial account comprises a predefined number of financial transactions or a predefined time period.

21. The method of claim 19, wherein the information about when to communicate messages to the person associated with the financial account comprises a type of financial transaction.

22. A computer program product for providing an audio message containing financial transaction information, the computer program product comprising a computer-readable medium having computer-readable program instructions stored therein, wherein said computer-readable program instructions comprise:
first instructions configured for storing information about a financial account, wherein the information about the financial account includes information about a system to use to communicate a message to a person associated with the financial account, wherein the message comprises an audio component;
second instructions configured for receiving an indication of a financial transaction affecting the financial account; and
third instructions configured for communicating a message comprising an audio component to the person associated with the financial account by using the system; wherein the message comprises information relating to the financial transaction.

23. The computer program product of claim 22, wherein the message comprises the date of the financial transaction, the amount of the financial transaction, or the identity of a party involved in the transaction.

24. The computer program product of claim 22, wherein the person associated with the financial account comprises a consumer making a purchase as at least part of the financial transaction.

25. The computer program product of claim 24, wherein the instructions for communicating a message comprising an audio component comprise instructions configured for transmitting an MMS, email, voicemail, or automated telephone call.

26. The computer program product of claim 25, wherein the information about a system comprises a telephone number or email address associated with the person associated with the financial account.

27. The computer program product of claim 22, wherein the instructions for communicating a message comprising an audio component comprise instructions for posting an audio file to a website accessible by a remote device via a network.

28. The computer program product of claim 22, wherein the information about the financial account further includes information about when to communicate messages to the person associated with the financial account.

29. The computer program product of claim 28, wherein the information about when to communicate messages to the person associated with the financial account comprises a predefined number of financial transactions or a predefined time period.

30. The computer program product of claim 28, wherein the information about when to communicate messages to the person associated with the financial account comprises a type of financial transaction.

31. An apparatus comprising:
a communication device;
a memory device; and
a processing device communicably coupled to the communication device and the memory device, wherein the processing device is configured to:
obtain via a network and store in the memory device instructions for decrypting an encrypted message from a financial institution comprising an audio component;
access an encrypted message from a financial institution comprising an audio component, wherein the audio component comprises information relating to a financial transaction associated with a user of the apparatus;
decrypt the message using the instructions; and
instruct the communication device to audibly communicate the audio component of the message to the user.

32. The apparatus of claim 31, wherein the audio component comprises the date of the financial transaction, the amount of the financial transaction, or the identity of a party involved in the transaction.

33. The apparatus of claim 31, wherein the apparatus is a mobile telephone.
